(19) United States
(12) Patent Application Publication
(10) Pub. No.: US 2014/0270578 A1
(43) Pub. Date: Sep. 18, 2014

(54) DEPLOYABLE FLUID COLLECTION BAG AND METHOD OF FORMING THE SAME

(71) Applicants: Emmett J. Ebner, Santa Ana, CA (US); Brian J. Huffer, Santa Ana, CA (US)

(72) Inventors: Emmett J. Ebner, Santa Ana, CA (US); Brian J. Huffer, Santa Ana, CA (US)

(21) Appl. No.: 13/829,935

(22) Filed: Mar. 14, 2013

(51) Int. Cl. B65D 33/00; B31B 41/00

(52) U.S. Cl. CPC B65D 33/00; B31B 41/00
USPC 383/10; 383/108; 493/210

(57) ABSTRACT

A deployable foldable fluid collection bag is provided which may be selectively deployable as desired by a user. The bag includes a first panel having a first edge and an opposing second edge. The first panel defines a base region, a first sidewall region, and a second sidewall region. The bag additionally includes a second panel having a second panel peripheral edge coupled to the first edge to define a fluid-tight seam between the second panel and base region, the first sidewall region and the second sidewall region. A third panel having a third panel peripheral edge is coupled to the second edge to define a fluid-tight seam between the third panel and the base region, the first sidewall region and the second sidewall region.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

1. Field of the Invention

The present invention relates generally to a fluid collection device, and more specifically, to a deployable, flexible fluid collection bag and a method of forming the same.

2. Description of the Related Art

It is very common for a drain connected to a kitchen sink to become blocked, or for a waste disposal unit to become inoperable. Repair of the kitchen sink or the waste disposal typically requires removal of at least a portion of the plumbing line running to the kitchen sink, or disconnection of the waste disposal from the plumbing lines. Although the water line may be turned off, water or fluid already present in the plumbing lines may leak or flow out when such repairs are performed. As can be appreciated, it is undesirable to allow the fluid to leak into the space under the kitchen sink. Therefore, various receptacles are typically placed under the leak to catch the fluid.

Due to the cramped space and plumbing lines extending under the kitchen sink, conventional buckets and pails may not easily fit within the space under the sink to catch the fluid. Thus, various supplies commonly found in the kitchen, such as pots, pans, cookie sheets, etc. are oftentimes employed as fluid collection devices to collect the fluid as it leaks from the plumbing.

Given that the aforementioned kitchen supplies are not specifically tailored for such use, it can be appreciated that there are several deficiencies associated therewith. One problem is that the supplies may not be able to effectively collect the fluid as it leaks. For instance, a cookie sheet is very shallow and may not have enough fluid capacity to collect all of the leaking fluid, or the fluid may splash outside of the cookie sheet as it leaks out.

Another problem associated with conventional kitchen supplies is that they are generally rigid in nature. More specifically, pots, pans, and cookie sheets are typically formed from cast metal, such as stainless steel, copper, etc. and do not offer much flexibility when being placed in cramped quarters, such as under the kitchen sink. In this regard, they may not be able to fit around many of the pipes or other plumbing fixtures disposed under this sink.

In addition, although fluid leaking from kitchen sink repairs may be relatively clean in most cases, it is also possible that the fluid may have particulate suspended therein (i.e., dirty water). Furthermore, other plumbing repairs may produce leakage of dirty fluid. An exemplary repair associated with dirty fluids is replacement of a toilet. In such a repair, sewage may leak from the toilet as it is removed from the floor. Therefore, it is desirable to collect the leaking fluid within a container which is disposable to allow the dirty fluid to be easily disposed of. Moreover, if certain plumbing fixtures or accessories are removed containing the dirty fluid, it is desirable to transport such fixtures and accessories within a receptacle that would mitigate further leakage of the dirty fluid.

In addition to aforementioned problems/deficiencies associated with receptacles used in plumbing applications, receptacles used for other purposes also suffer from similar deficiencies. For instance, conventional grocery bags routinely break, which causes food items to roll in the ground or in the car. Conventional grocery bags are also small and thus, users attempt to carry multiple bags at one time, which may be strenuous or lead to inadvertent spilling of one or more bags.

Moreover, the deficiencies associated with conventional receptacles have resulted in a general reluctance to use receptacles. For instance, individuals commonly transport plants in their trunk, which typically leads to the plant tipping in the trunk and dirt spilling in the car. Furthermore, dirty sports equipment is routinely transported freely in a vehicle, which tends to soil the vehicle. With regard to general storage, such items such as paint, tools, and craft supplies are commonly scattered around a room.

As is apparent from the foregoing, there exists a need in the art for a deployable fluid collection bag and a method of forming the same, wherein the bag can be deployed during conventional plumbing repairs to collect fluid and to facilitate transport of the fluid for disposal. There is also a need for a multi-use receptacle that can be easily deployed to store and transport various items. The present invention addresses this particular need, as will be discussed in more detail below.

### BRIEF SUMMARY OF THE INVENTION

According to an aspect of the present invention, there is provided a deployable, foldable fluid collection bag which may be selectively deployed as desired by the user. The bag may be configured to fit in tight spaces and be deployed to collect fluid which leaks during plumbing repairs and installations. The bag is also flexible to enable bending or folding around plumbing lines and fixtures when placing the bag under the leak. Furthermore, the bag may also define an internal stiffness or rigidity suitable to allow the bag to remain upright when deployed to contain the fluid capture within the bag. The configuration of the bag may also allow the bag to be used in various other applications.

According to one embodiment, the bag includes a first panel having a first edge and an opposing second edge. The first panel defines a base region, a first sidewall region, and a second sidewall region. The first and second edges are both collectively defined by the base region, the first sidewall region and the second sidewall region. The bag additionally includes a second panel having a second panel peripheral edge coupled to the first edge to define a fluid-tight seam between the second panel and base region, the first sidewall region and the second sidewall region. A third panel having a third panel peripheral edge is coupled to the second edge to define a fluid-tight seam between the third panel and the base region, the first sidewall region and the second sidewall region. The fluid collection bag is deployable with the first sidewall region in opposed relation to the second sidewall region, and the second panel in opposed relation to the third panel.

The first panel, the second panel, and the third panel may include at least one aperture formed respectively therein to define at least one handle.

The second panel and the third panel may be configured to be independently and selectively moveable relative to the base region between a collapsed position and a deployed position.

The first, second and third panels may be fabricated from a plastic material.

The first sidewall region and the base region may define a first fold-line therebetween and about which the first sidewall region is transitionable between deployed and collapsed positions. The second sidewall region and the base region may define a second fold-line therebetween and about which the second sidewall region is transitionable between deployed and collapsed positions.

The second panel peripheral edge may include a second panel base segment and a pair of second panel perpendicular segments extending substantially perpendicularly from the second panel base segment. The second panel base segment may be coupled to the base region, and the pair of second panel perpendicular segments may be coupled to respective ones of the first and second sidewall regions.

The third panel peripheral edge may include a third panel base segment and a pair of third panel perpendicular segments extending substantially perpendicularly from the third base segment. The third panel base segment may be coupled to the base region, and the pair of third panel perpendicular segments being coupled to respective ones of the first and second sidewall regions.

According to another aspect of the present invention, there is provided a method of forming a deployable fluid collection bag. The method includes providing a first sheet of plastic material including a first edge and an opposing second edge. The first panel defines a base region, a first sidewall region, and a second sidewall region, wherein the first and second edges both being collectively defined by the base region, the first sidewall region and the second sidewall region. The method additionally includes providing a second sheet of plastic material having a second panel peripheral edge, and providing a third sheet of plastic material having a third panel peripheral edge. The second panel peripheral edge is connected to the first edge of the first sheet to define a fluid-tight seam between the second panel and the first sidewall region, the second sidewall region and the base region. The third panel peripheral edge is connected to the second edge of the first sheet to define a fluid-tight seam between the third panel and the first sidewall region, the second sidewall region and the base region.

The method may additionally include forming a pair of apertures in the first panel in respective ones of the first sidewall region and the second sidewall region to define a pair of handles. The method may also include the step of forming a pair of apertures in respective ones of the second panel and the third panel to defines a pair of handles.

The present invention is best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings in which like numbers refer to like parts throughout and in which:

FIG. 1 is an upper perspective view of a fluid collection bag constructed in accordance with an embodiment of the present invention; and

FIG. 2 is a top plan view of the fluid collection bag in an unassembled configuration.

### DETAILED DESCRIPTION OF THE INVENTION

The detailed description set forth below in connection with the appended drawings is intended as a description of the presently preferred embodiments of the invention, and is not intended to represent the only form in which the present devices may be developed or utilized. It is to be understood, however, that the same or equivalent functions may be accomplished by different embodiments that are also intended to be encompassed within the spirit and scope of the invention. It is further understood that the use of relational terms such as first, second, and the like are used solely to distinguish one from another entity without necessarily requiring or implying any actual such relationship or order between such entities.

Referring now to the drawings, wherein the showings are for purposes of illustrating a preferred embodiment of the present invention and are not for purposes of limiting the same, FIGS. 1 and 2 illustrate one embodiment of a deployable, foldable fluid collection bag 10 sized and configured to allow the bag 10 to be easily deployed to collect fluid while performing plumbing repairs, remodels, or installations, such as repairs under a kitchen sink. According to one implementation, the bag 10 employs a unique construction comprised of three separate panels 12, 28, 32 which are joined via fluid tight seams 25, 35 to define the bag 10 so as to prevent fluids collected within the bag 10 from leaking or flowing out of the bag 10.

According to one embodiment, the bag 10 includes a first panel 12 having a first sidewall region 14, a second sidewall region 16, and a base region 18 positioned between the first and second sidewall regions 14, 16. As will be explained in more detail below, the first sidewall region 14 and the base region 18 are separated by a first fold line 20, while the second sidewall region 16 and the base region 18 are separated by a second fold line 22. The first panel 12 is formed from a single sheet of material, with the first and second sidewall regions 14, 16 being integral with the base region 18.

The first panel 12 includes a first edge 24 and an opposing second edge 26 disposed in spaced relation to the first edge 24. In the exemplary embodiment, the first and second edges 24, 26 extend in generally parallel relation to each other when the first panel 12 is extended in a planar configuration (as shown in FIG. 2), although those skilled in the art will recognize that other embodiments of the bag 10 may include first and second edges 24, 26 that include non-parallel segments.

Both the first and second edges 24, 26 extend along the first sidewall region 14, the second sidewall region 16, and the base region 18 on opposed sides of first panel 12. Along these lines, the first edge 24 includes a first sidewall segment 24a, a second sidewall segment 24b, and a base segment 24c. The first edge 24 is preferably continuous, with no interruptions between the first sidewall segment 24a and the base segment 24c, or between the second sidewall segment 24b and the base segment 24c. The second edge 26 also includes a first sidewall segment 26a, a second sidewall segment 26b, and a base segment 26c, which preferably define a continuous second edge 26.

The bag 10 additionally includes a second panel 28 separate from the first panel 12. The second panel 28 includes a second panel peripheral edge 30 having a base segment 30c, a first perpendicular segment 30a and a second perpendicular segment 30b. The first and second perpendicular segments 30a,b are generally perpendicular to the base segment 30c and are disposed in generally parallel, spaced relation to each other.

The second panel peripheral edge 30 is coupled to the first edge 24 to define a fluid-tight seam 25 between the second panel 28 and the first panel 12. More specifically, the first perpendicular segment 30a is coupled to the first sidewall segment 24a, the second perpendicular segment 30b is coupled to the second sidewall segment 24b, and the base segment 30c is coupled to the base segment 24c.

The bag 10 further includes a third panel 32 separate from the first and second panels 12, 28, with the third panel 32 having a configuration that is similar to the second panel 28. Along these lines, the third panel 32 includes a third panel peripheral edge 34 includes a base segment 34c, a first perpendicular segment 34a and a second perpendicular segment 34b. The first and second perpendicular segments 34a,b are generally perpendicular to the base segment 34c and are disposed in generally parallel, spaced relation to each other.

The third panel peripheral edge 34 is coupled to the second edge 26 to define a fluid-tight seam 35 between the third panel 32 and the first panel 12. More specifically, the first perpendicular segment 34a is coupled to the second sidewall segment 26a, the second perpendicular segment 34b is coupled to the second sidewall segment 26b, and the base segment 34c is coupled to the base segment 26c.

The fluid collection bag 10 is configured to be transitional/deployable between a stowed configuration and a deployed configuration. FIG. 1 shows the bag 10 in the deployed configuration and the first sidewall region 14, second sidewall region 16, second panel 28 and third panel 32 are all in an upright position relative to the base region 18. According to one aspect of the invention, the first sidewall region 14, second sidewall region 16, second panel 28 and third panel 32 are generally perpendicular to the base region 18 when the bag 10 is in the deployed configuration. The bag 10 is preferably formed from a suitable material having sufficient rigidity to allow the bag 10 to remain in the upright configuration without any external support for the upright panels 14, 16, 28, 32.

In the stowed configuration the bag 10 is collapsed from the deployed configuration to facilitate storage of the bag 10. According to one embodiment, the first sidewall region 14, second sidewall region 16, second panel 28 and third panel 32 are independently and selectively folded toward the base region 18 as the bag 10 transitions from the deployed configuration toward the stowed configuration. In particular, the first sidewall region 14 is folded about the first fold line 20, the second sidewall region 16 is folded about the second fold line 22. The second panel 28 is folded about the seam 25 adjacent the base segments 24c, 30c, and the third panel 32 is folded about the seam 35 adjacent the base segments 26c, 34c. In the stowed configuration, the first sidewall region 14, second sidewall region 16, second panel 28 and third panel 32 may overlap with the base region 18.

Those skilled in the art will readily appreciate that the bag 10 may transition from the deployed configuration toward the stowed configuration in different fashions (i.e., without folding the sidewall regions 14, 16 and panels 28, 32). For instance, the bag 10 may be collapsed and rolled toward a stowed configuration.

According to various aspects of the present invention, the bag 10 includes one or more handles to facilitate lifting and carrying thereof. The first panel 12 preferably includes at least one handle, and in the exemplary embodiment, the first panel 12 includes two handles 36, 38 formed in respective ones of the first sidewall region 14 and the second sidewall region 16. Each handle 36, 38 includes a respective aperture 40, 42 and a corresponding gripping body 44, 46. The exemplary embodiment additionally includes handles 48, 50 formed in respective ones of the second and third panels 24, 32. The handles 48, 50 each include respective apertures 52, 54 and corresponding gripping bodies 56, 58.

The apertures 40, 42, 52, 54 used to form the handles 36, 38, 48, 50 may be cut, stamped or formed within the respective panels 12, 28, 32 via other techniques known by those skilled in the art. The handles 36, 38 may be positioned within the first and second sidewalls regions 14, 16 such that when a user brings the first and second sidewalls regions 14, 16 together, the handles 36, 38 are aligned to allow the user's hand to easily grasp both handles 36, 38. Likewise, the handles 48, 50 may be positioned with the second and third panels 28, 32 such that when a user brings the second and third panels 28, 32 together, the handles 48, 50 are aligned to allow the user's hand to easily grasp both handles 48, 50.

The bag 10 is preferably fabricated from a plastic material, such as 6 ml polyethylene or 5 ml polypropylene, however, other materials or thicknesses may be used without departing from the spirit and scope of the present invention.

The bag 10 is specifically configured and adapted to enhance the fluid-tight nature thereof by reducing the number of seams or junctions needed to form the bag 10, particularly along the base region 18 of the bag 10, which typically bears the greatest load applied by the fluid collected in the bag 10. The construction of the bag 10 additionally simplifies manufacturing of the bag 10 by minimizing the amount of folding that is required to form the bag 10. The bag 10 is also flexible to allow the bag 10 to be deployed in tight spaces.

With the basic structural features of the bag 10 described above, the following discussion pertains to the method of constructing the bag 10. The method includes providing the first panel 12, the second panel 28 and the third panel 32. The panels 12 may be cut, stamped, or formed by other means known in the art. The second panel peripheral edge 30 is connected to the first edge 24 of the first sheet/panel 12 to define a fluid-tight seam 25 between the second panel 28 and the first sidewall region 14, the second sidewall region 16 and the base region 18. Similarly, the third panel peripheral edge 34 is connected to the second edge 26 of the first sheet/panel 12 to define a fluid-tight seam 35 between the third panel 32 and the first sidewall region 14, the second sidewall region 16 and the base region 18.

The method of forming the bag 10 may additionally include forming the apertures 40, 42, 52, 54 in the first sidewall region 14, second sidewall region 16, second panel 28 and the third panel 32, respectively.

In use, the bag 10 may be easily deployed when performing plumbing repairs or installations to collect leaking fluid. Prior to use, the bag 10 may be in a folded configuration, wherein the sidewalls regions 14, 16 and the second and third panels 28, 32 are folded onto the base region 18. The bag 10 may then be unfolded or deployed to define a cavity 60 for catching the leaking fluid. The foldable nature of the bag 10 may allow the bag 10 to be used in tight spaces, as is commonly the case during plumbing repairs. For instance, the bag 10 shown in FIG. 1 is configured for use during a plumbing repair or installation under the kitchen sink. Conventional kitchens typically include a pair of cabinet doors which provide access to the space under the sink and to the plumbing line and a waste disposal unit. (See U.S. patent application Ser. Nos. 13/169,819 and 13/044,163, both entitled Deployable Fluid Collection Bag and Method of Forming the Same, and owned by Applicant of the present invention, the disclosures of which are expressly incorporated herein by reference). The bag 10 may be bent and folded to pass under and around the plumbing line and the waste disposal unit to position the bag 10 such that during the repair, any fluid that may leak may be caught within the bag 10. Along these lines, the bag 10 may define enough internal stiffness and rigidity to maintain the sidewall regions 14, 16 and the panels 28, 32 in a generally upright configuration to catch the fluid, and to contain the fluid within the bag 10. In other words, the weight of the fluid should not cause the sidewall regions 14, 16 and the panels 28, 32 to collapse.

Once the repairs or installation are complete, the user may grasp the handles 48, 50, 52, 54 to remove the bag 10 from the kitchen compartment. It is contemplated that the bag 10 may be disposable to allow the user to easily dispose of the bag 10 and the collected fluid. However, it is also contemplated that the user may simply pour out the collected fluid to allow the bag 10 to be reused.

Although the foregoing describes the bag 10 as being usable during kitchen plumbing repairs, those skilled in the art will appreciate that the bag 10 may also be used in relation to other plumbing procedures. For instance, the bag 10 may be used in connection with replacement of a toilet. In particular, the toilet being removed and replaced may be placed within the bag 10 after it is removed from the floor of the bathroom. The bag 10 may be used to transport the toilet from the bathroom during disposal of the toilet to catch any fluid or sewage that may be present in the toilet.

In addition to the plumbing applications noted above, it is additionally contemplated that the bag 10 is widely adaptable for use in several other applications. For instance, the bag 10 may be used as a grocery tote, wherein the bag 10 is loaded directly with groceries, or with several individual grocery bags to contain them in a vehicle and to simplify transport of the groceries from the vehicle into the home (i.e., the user only carries one bag 10 as opposed to several conventional grocery bags). The bag 10 may also be used to transport plants and plant supplies to protect the vehicle from inadvertent tipping and spilling of dirt into the vehicle.

The fluid-tight qualities and internal stiffness of various embodiments of the bag 10 make the bag 10 useful for storing/transporting ice or drinks. Along these lines, drinks and ice may be placed in the bag 10, which is easily transportable during a party. The compactable nature of the bag 10 makes the bag 10 easy to breakdown during cleanup.

The bag 10 may also be used for storage purposes, such as for storing toys, sports equipment, wetsuits, bathing suits, laundry, shoes, cosmetics, tools, paint, paint supplies, crafts, etc. The items may be stored in the bag 10 which may be placed neatly on a shelf for organized storage of the items. Along these lines, it is understood that the bag 10 may be constructed in various shapes and sizes to accommodate the wide range of applications for which the bag 10 may be employed.

It is contemplated that the uses of the bag 10 discussed herein and shown in the Figures are exemplary in nature only and are not intended to limit the scope of the present invention. Along these lines, those skilled in the art may contemplate other uses of the bag 10 which are not discussed or shown herein.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combinations described herein. Thus, the scope of the claims is not to be limited by the illustrated embodiments.

What is claimed is:

1. A deployable fluid collection bag comprising:
a first panel having a first edge and an opposing second edge, the first panel defining a base region, a first sidewall region, and a second sidewall region, the first and second edges both being collectively defined by the base region, the first sidewall region and the second sidewall region;
a second panel having a second panel peripheral edge coupled to the first edge to define a fluid-tight seam between the second panel and base region, the first sidewall region and the second sidewall region; and
a third panel having a third panel peripheral edge coupled to the second edge to define a fluid-tight seam between the third panel and the base region, the first sidewall region and the second sidewall region;
the fluid collection bag being deployable with the first sidewall region in opposed relation to the second sidewall region, and the second panel in opposed relation to the third panel.

2. The deployable fluid collection bag of claim 1, wherein the first panel includes at least one aperture formed therein to define a handle.

3. The deployable fluid collection bag of claim 2, wherein the first panel includes pair of aperture formed within respective ones of the first sidewall region and the second sidewall region to define a pair of handles.

4. The deployable fluid collection bag of claim 1, wherein the second panel includes at least one aperture formed therein to define a handle.

5. The deployable fluid collection bag of claim 4, wherein the third panel includes at least one aperture formed therein to define a handle.

6. The deployable fluid collection bag of claim 1, wherein the second panel and the third panel are configured to be independently and selectively moveable relative to the base region between a collapsed position and a deployed position.

7. The deployable fluid collection bag of claim 1, wherein the first panel is formed from a single sheet of material.

8. The deployable fluid collection bag of claim 7, wherein the first, second and third panels are fabricated from a plastic material.

9. The deployable fluid collection bag of claim 1, wherein the first sidewall region and the base region define a first fold-line therebetween and about which the first sidewall region is transitionable between deployed and collapsed positions.

10. The deployable fluid collection bag of claim 9, wherein the second sidewall region and the base region define a second fold-line therebetween and about which the second sidewall region is transitionable between deployed and collapsed positions.

11. The deployable fluid collection bag of claim 1, wherein the second panel peripheral edge includes a second panel base segment and a pair of second panel perpendicular segments extending substantially perpendicularly from the second panel base segment, the second panel base segment being coupled to the base region, and the pair of second panel perpendicular segments being coupled to respective ones of the first and second sidewall regions.

12. The deployable fluid collection bag of claim 11, wherein the third panel peripheral edge includes a third panel base segment and a pair of third panel perpendicular segments extending substantially perpendicularly from the third base segment, the third panel base segment being coupled to the base region, and the pair of third panel perpendicular segments being coupled to respective ones of the first and second sidewall regions.

13. A method of forming a deployable fluid collection bag, the method comprising the steps of:
providing a first sheet of plastic material including a first edge and an opposing second edge, the first panel defining a base region, a first sidewall region, and a second sidewall region, the first and second edges both being collectively defined by the base region, the first sidewall region and the second sidewall region;
providing a second sheet of plastic material having a second panel peripheral edge;
providing a third sheet of plastic material having a third panel peripheral edge;
connecting the second panel peripheral edge to the first edge of the first sheet to define a fluid-tight seam between the second panel and the first sidewall region, the second sidewall region and the base region; and
connecting the third panel peripheral edge to the second edge of the first sheet to define a fluid-tight seam between the third panel and the first sidewall region, the second sidewall region and the base region.

14. The method of claim 13, further comprising the step of forming a pair of apertures in the first panel in respective ones of the first sidewall region and the second sidewall region to define a pair of handles.

15. The method of claim 13, further comprising the step of forming a pair of apertures in respective ones of the second panel and the third panel to defines a pair of handles.

16. A deployable fluid collection bag comprising:
a first panel having a pair of apertures formed therein adjacent opposing end portions thereof to define a pair of handles;
a second panel having a second panel peripheral edge coupled to the first panel to define a fluid tight seam between the first panel and the second panel; and
a third panel having a third panel peripheral edge coupled to the first panel in opposed spaced relation to the second panel to define a fluid tight seam between the first panel and the third panel.

17. The deployable fluid collection bag of claim 16, wherein the second panel includes at least one aperture formed therein to define a handle.

18. The deployable fluid collection bag of claim 17, wherein the third panel includes at least one aperture formed therein to define a handle.

19. The deployable fluid collection bag of claim 16, wherein the second panel and the third panel are configured to be independently and selectively moveable relative to the first panel between a collapsed position and a deployed position.

20. The deployable fluid collection bag of claim 16, wherein the first, second and third panels are fabricated from a plastic material.
